(19) United States
(12) Patent Application Publication
(10) Pub. No.: US 2017/0173515 A1
(43) Pub. Date: Jun. 22, 2017

(54) FACILITY AND METHOD FOR PURIFICATION BY ADSORPTION OF A GASEOUS FLOW COMPRISING A CORROSIVE IMPURITY

(71) Applicant: L'Air Liquide, Société Anonyme pour I'Etude et I' Exploitation des Procédés Georges Claude, Paris (FR)

(72) Inventors: Thierry GESBERT, Verrieres le Buisson (FR); Christian MONEREAU, Montpellier (FR); Elise RENOU, Paris (FR); Romain BONAY, Le Perreux sur Marne (FR)

(21) Appl. No.: 15/129,638

(22) PCT Filed: Feb. 19, 2015
(86) PCT No.: PCT/FR2015/050403

§ 371 Date: Sep. 27, 2016

(30) Foreign Application Priority Data
Mar. 28, 2014 (FR) 1452705

(51) Int. Cl. B01D 53/04; B01D 53/047

(52) U.S. Cl. CPC B01D 53/0462; B01D 53/047; B01D 53/0431; B01D 2257/302; B01D 2257/404; B01D 2257/2045; B01D 2257/2047; B01D 2258/02

(57) ABSTRACT

The invention relates to a facility for purification by adsorption of gaseous flow comprising at least one impurity which has a corrosive effect on carbons steel, comprising a radial adsorber comprising a housing with an outer envelope made of carbon steel; a vertical perforated inner grating consisting of a corrosion-resistant material, a vertical perforated outer grating, an adsorbent which is held vertically by the outer grating and the inner grating, and allows at least partial blockage of the corrosive impurity, and a means for allowing a centrifugal circulation of the gaseous flow.

### CROSS REFERENCE TO RELATED APPLICATIONS

This application is a 371 of International PCT Application PCT/FR2015/050403 filed Feb. 19, 2015 which claims priority to French Patent Application No. FR 1452705 filed Mar. 28, 2014, the entire contents of which are incorporated herein by reference.

### BACKGROUND

The present invention relates to an adsorption plant for purifying a gas stream comprising at least one impurity that is corrosive with respect to carbon steel.

Adsorption is widely used for purifying or separating gases. Mention may be made of the separation of n-paraffins and isoparaffins, the separation of xylenes or of alcohols, the production of nitrogen or oxygen from atmospheric air, the stripping of CO₂ from combustion gases, blast furnace gases, etc. In terms of purification, there are dryers, the purification of hydrogen or helium, the purification of methane-rich gases, the adsorption of impurities in trace amounts in numerous fluids (stopping mercury, NOx, sulphur-containing products, etc.).

The processes that use adsorption are of several types depending on whether the adsorbent can or cannot be regenerated in situ. Thus reference is made to “lost-charge” adsorption, i.e. adsorption where the charge has to be renewed when the product is saturated with impurities (use is made in this case of the term “guard bed” to describe such a purification), or to adsorption cycles in the other case.

The adsorption cycles differ firstly by the manner in which the adsorbent is regenerated. If the regeneration is carried out essentially by increasing the temperature, it is a TSA (Temperature Swing Adsorption) process. If, on the other hand, the regeneration takes place by lowering the pressure, it is a PSA (Pressure Swing Adsorption) process. A PSA process is understood to mean actual PSA processes, i.e. with the adsorption phase which is carried out at a pressure substantially higher than the atmospheric pressure, and the regeneration phase which is carried out at a pressure slightly higher than the atmospheric pressure; VSA (Vacuum Swing Adsorption) processes for which the adsorption phase is carried out at a pressure of the order of the atmospheric pressure and the regeneration is carried out under vacuum; VPSA and the like (MPSA, MSA, etc.) processes with an adsorption phase that is carried out at a few bar and the regeneration is carried out under vacuum. This category also includes the systems that are regenerated by flushing with a purge gas (or elution gas), which gas may be external to the process itself. In this case, the partial pressure of the impurities is in fact lowered, which enables the desorption thereof.

The adsorbent is used in reactors that will be referred to hereinafter as adsorbers. These adsorbers are themselves also of various types depending on their geometry. The simplest adsorber is of cylindrical shape with a vertical axis. When the flow rates to be purified become sizeable, it is possible to use cylindrical adsorbers with a horizontal axis. Above a certain flow rate and/or if small pressure drops are desired and/or if the speed of the gas may be greater than the rate of attrition (of movement of the beads) at least in certain steps of the cycle, it becomes advantageous to use a radial adsorber.

For example, as soon as the flow rates to be purified reach several tens of thousands of actual cubic meters (i.e. counted under the operating conditions) per hour, it is indeed known to use radial adsorbers as is taught in document U.S. Pat. No. 4,541,851 or in document EP 1 638 669.

Specifically, radial adsorbers make it possible to reliably carry out the purification or the separation of large amounts of fluid by enabling, due to their geometry, a great freedom of choice for the circulation rates of said fluids, in particular in order to make them compatible with the mechanical properties of the particles of adsorbent used, while ensuring a good gas distribution through the adsorbent masses. This flexibility originates from the fact that the flow area of the gas is a function of the diameter and of the height of the grids and not of the diameter alone as for a standard adsorber. They are therefore used in particular for the drying and decarbonation of air before the cryogenic fractionation thereof, in the case of oxygen VSA plants, and are particularly well suited to CO₂ VSA or PSA plants, units that have to handle very high flow rates (several hundreds of thousands of Nm³/h) at low (1 to 3 bar abs), medium (less than or equal to 15 bar abs) or even relatively high (greater than 15 bar abs) pressure, with regeneration under vacuum, at atmospheric pressure, or under pressure. The adsorption and regeneration pressures are selected as a function of the overall process.

There are numerous configurations for the use of radial adsorbers. By referring to FIG. 1 and taking as reference the adsorption phase, the gas may circulate from the inside to the outside (centrifugal circulation F) or from the outside to the inside (centripetal circulation P). The gas may enter through the bottom 3 or through the top 1 and leave likewise through the bottom 2 or through the top 4. Depending on the case, the gas will travel from the top to the bottom (b) or from the bottom to the top (h) in the central portion or at the periphery. By referring to FIG. 1, it is therefore possible to have centrifugal circulations in adsorption of the type for example (successive directions: 1-b-F-b-2] with entry through the top and exit through the bottom or else (successive directions: 1-b-F-h-4), the entry and exit then taking place in the upper portion through separate pipes. The regeneration may take place in the same direction as the adsorption (co-current regeneration) or more generally in the reverse direction (counter-current regeneration). Other more complex configurations have been used. Another possible arrangement consists for example in adding a circular sealing disk in order to divide the adsorbent mass into two portions. It is then possible in one and the same radial adsorber to have, in adsorption phase for example, a centrifugal circulation in a first volume of adsorbent followed by a centripetal circulation in the upper volume of adsorbent, i.e. for example for an inlet in the lower portion and an outlet through the top (successive directions: 3-h-F-h-P-h-4).

It is known that atmospheric air contains compounds that have to be eliminated before introducing said air into the heat exchangers of the cold box of an air separation unit, in particular the compounds carbon dioxide (CO₂), water vapor (H₂O), nitrogen oxides and/or hydrocarbons for example. Indeed, in the absence of such pretreatment of the air to eliminate its impurities, CO₂ and water, therefrom, these impurities will solidify as ice when the air is cooled to a cryogenic temperature, typically less than or equal to −150° C., which may result in problems of the equipment, especially heat exchangers, distillation columns, etc., being blocked.

In addition, it is also customary to at least partially eliminate the hydrocarbon and nitrogen oxide impurities liable to be present in the air in order to avoid too high a concentration thereof in the bottom of the distillation column(s), and hence any risk of degradation of the equipment.

Conventionally, a TSA process cycle for air purification comprises the following steps:

a) purification of the air by adsorption of the impurities at superatmospheric pressure and at ambient temperature;

b) depressurization of the adsorber down to atmospheric pressure;

c) regeneration of the adsorbent at atmospheric pressure, in particular by the waste gases, typically impure nitrogen originating from an air separation unit and heated to a temperature customarily between 100° C. and 280° C. by means of one or more heat exchangers;

d) cooling of the adsorbent to ambient temperature, in particular by continuing to introduce therein said waste gas from the air separation unit, but not reheated;

e) repressurization of the adsorber with purified air resulting, for example, from another adsorber that is in production phase, or optionally with the air to be purified.

Generally, the air pretreatment devices comprise two adsorbers operating alternately, that is to say that one of the adsorbers is in production phase, while the other is in regeneration phase. The production phase corresponds to the purification of the gas mixture by adsorption of the impurities. The regeneration phase comprises the aforementioned depressurization, heating, cooling and repressurization steps.

A step of paralleling the two adsorbers, of relatively long duration, that is to say from a few seconds to several minutes, is generally added at the start or the end of the regeneration phase.

The operation of a radial adsorber for such an application is represented in FIG. 2.

The fluid 1 to be purified or to be separated enters at the bottom portion of the radial adsorber 10, passes through the adsorbent mass 20 and the purified fluid leaves at the top portion 2. During the regeneration, the regeneration fluid 3 enters countercurrently through the top portion, desorbs the impurities contained in the adsorbent mass 20 and the waste gas 4 leaves at the bottom portion.

The adsorber 10 itself consists of a cylindrical shell of vertical axis AA and two end walls. The adsorbent mass is kept in place by means of a perforated external grid 11 and a likewise perforated internal grid 12 that are fastened on the one hand to the upper end wall and on the other hand to a solid plate 13 in the lower portion. The fluid 1 to be purified or to be separated circulates vertically at the periphery in the external free zone 14 between the cylindrical shell and the external grid, passes radially through the adsorbent mass 20, then circulates vertically in the internal free zone 15 before leaving the adsorber through the top. The regeneration is carried out in the opposite direction.

In practice, the adsorbent material may consist of one and the same adsorbent, for example zeolite X or doped activated alumina, or comprise several beds.

Among the multiple beds, mention may be made of the activated alumina/zeolite X, silica gel/zeolite X, zeolite X/exchanged zeolite pairings. It may also be advantageous to use multilayers of the type: water-resistant silica gel, standard silica gel or activated alumina, zeolite X; or of the type: silica gel or activated alumina, zeolite X, exchanged zeolite.

FIG. 3 represents a radial adsorber comprising two separate layers of adsorbents. This adsorber also comprises other internal equipment (filter, distribution cone, etc.) which will be mentioned hereinafter.

Seen in FIG. 3 are: three perforated grids 5, 6, 7, the lower base thereof 8, the connecting parts 12 between the grids and an end wall, the two end walls 10 and 11 and the outer shell 9. This system makes it possible to keep the adsorbents constituting the annular-shaped beds 3 and 4 in place.

The connecting parts 12 may be of different shape and different dimensions depending on the precise technology used for the adsorbers. They may for example comprise removable hatches for accessing inter-grid spaces or the space between the outer grid and the shell. In other designs these are just components that enable the fastening of the grids with their ends. They are generally designed to prevent preferential pathways of the gas in the upper portion. They obviously ensure a perfect sealing between the internal and external gaseous volumes to prevent any (inlet/outlet) by-pass that would render the purification process ineffective.

Other elements, such as for example a filter in the central cylindrical space, a connecting part between the flange and said filter, a distribution cone internal to the filter, may complete the adsorber.

The direction of circulation of the gas in adsorption phase and in regeneration phase (centrifugal or centripetal) is not left to chance but is dependent on process constraints or technological constraints.

In a PSA where the flow rate decreases from the inlet to the outlet, the centripetal direction is generally chosen for the adsorption. Since the flow areas in this case decrease, from the external grid to the internal grid, this makes it possible to maintain the circulation rate of the gas and hence to limit the resistance to mass transfer in the fluid film surrounding the particles of adsorbent, which could otherwise become dominant and modify the kinetics. Furthermore, since the elution step takes place in the opposite direction, this also makes it possible to have the largest flow areas at the end where the outgoing flow rate is highest and to minimize the pressure drop during this crucial step in terms of performance.

There are cases however where it is advisable to adopt the centrifugal circulation solution. In the case of multibeds, it is found that often the first layer of adsorbent acts as a guard bed with respect to an impurity present at low concentration in the feed gas and that the volume of this layer is small relative to the total volume of adsorbant. A typical order of magnitude is 5% to 10%. Located at the periphery of the adsorber, this layer might represent only a few centimeters out of the width of the bed. Technologically, it becomes difficult to produce an adsorber with grids that are not spaced very far apart (problems of insertion, of construction tolerances, in particular). In this case, it is often preferred to have this first layer on the internal side, where the thickness, by simple geometry, may for example be 3 times greater for the same volume.

The vast majority of TSA have a centripetal adsorption for cost and/or energy consumption reasons. It should firstly be noted that for the great majority of TSA processes, the impurity or the impurities to be stopped are either in the form of trace amounts, or in any case are in the great minority in the feed gas. This is the case mentioned above for purifications of air, but also for dryings and purifications of gas such as syngas before cryogenic hydrogen/carbon monoxide separation, natural gas, stopping of volatile organic compounds, etc. The feed gas flow rate between the inlet and the outlet varies little and is not a criterion for the choice of the circulation direction.

When saturated, the adsorbent is regenerated by circulation of a gas at high temperature, generally between 100° C. and 280° C. For the sake of optimization, during the heating phase, it is common to introduce only the amount of heat needed, which means that, at the outlet, the gas never leaves with a very high temperature. For a regeneration temperature of 150° C., the peak, i.e. maximum, temperature at the outlet might be from 50° C. to 60° C. for example. In order to avoid having to heat the outer shell with the regeneration gas, which would involve both an energy loss and the requirement to invest in insulation, it is common to make the regeneration gas enter in the central portion of the radial adsorber. There is thus no heat loss to the surroundings and the outer shell, which only experiences a moderate temperature, has no need to have thermal insulation. The regeneration therefore takes place conventionally in a centrifugal manner and the adsorption which is in the opposite direction is therefore centripetal: the atmospheric air is introduced through an end wall, circulates at the periphery between the shell and the external grid, passes radially through the adsorbent mass, is recovered, dry and decarbonated, at the center and discharged through one of the end walls.

Radial adsorbers are very generally made of carbon steel for cost reasons even though it is known that carbon steel is moderately resistant to corrosion despite the protective layer that it naturally develops at its surface and even though atmospheric air has a tendency to corrode in particular due to its moisture and the presence of carbon dioxide.

However, the corrosion linked to the customary impurities of atmospheric air and to the operating conditions of these adsorbers is low enough so that a corrosion allowance of a few millimeters (2 to 3 generally) is sufficient to guarantee maintaining the minimum thickness necessary for the mechanical behavior over periods considerably greater than 10 years.

There are however industrial sites where the air is more polluted than normal or locations, such as coastline locations for example or on sea-going barges, or at gas or oil fields, for which a simple corrosion allowance could rapidly be insufficient. Certain constituents are capable not only of rapidly corroding the carbon steel but also of chemically attacking certain adsorbents and of destroying them.

One solution then consists in introducing a pretreatment upstream of the TSA air purification process, referred to as FEP. In a chemical factory where the air could periodically contain for example traces of HCl, a low-pressure “filter” could be installed, at the intake of the air compressor for example. This equipment will for example be an adsorber, itself also of radial type, containing a lost charge of a constituent that stops traces of HCl. A bed of zeolite 13X or of activated alumina generally fits the bill. More specific products could however be used if necessary. The charge is renewed periodically, for example every six months.

In a set number of cases, a simple filter is not sufficient since the corrosive species may be of several types and/or in an amount too high for solutions of this type.

Without wishing to go into detail here, it is known that many constituents such as chloride, fluoride, SO₄²⁻, NO₃⁻ ions or caustic compounds, may locally destroy the natural protection developed by the carbon steel and attack the metal in depth. The oxygen and water present in the air are an aggravating element. The operating conditions of the equipment (temperature, presence of liquid water during the regeneration, etc.) also act as a corrosion accelerator. These unfavorable conditions are combined at certain sites, in particular where certain ores (copper in particular) are treated.

The air is then washed through columns that often have packing in order to limit the pressure drops. Additives are added to the water depending on the nature of the impurities to be removed. The last washing operation is generally carried out with water to avoid any entrainment of chemicals to the equipment downstream, in particular the FEP. The latter is then the subject of a standard design.

Although this solution has proven its effectiveness, the fact remains that it has at least three drawbacks: its cost (large-diameter columns, cost of the additives), the energy consumption (means for pumping the washing waters, pressure drop with low-pressure air) and the pollution of a large amount of water (with the impurities or chemicals formed highly diluted). The increasingly strict pollution control standards make it necessary to treat these washing waters before any discharge, which requires large-sized plants that are expensive in terms of investment (tank, storage) and in terms of operation (chemicals, pumping, analyses). Starting from here one problem that is faced is to find a new means of dealing with these problems of impurities.

### SUMMARY

One solution of the present invention is an adsorption plant for purifying a gas stream comprising at least one impurity that is corrosive with respect to carbon steel, which plant comprises a radial adsorber comprising:
a shell with an outer envelope made of carbon steel;
a vertical and perforated internal grid made of corrosion-resistant material;
a vertical and perforated external grid;
an adsorbant held vertically by the external grid and the internal grid that makes it possible to at least partially stop said corrosive impurity; and
means that enable a centrifugal circulation of the gas stream.

The following definitions are understood:
“corrosion-resistant material”: a non-corrodible material, i.e. that is physically or chemically insensitive to the compounds in contact, or that has a low enough corrosion rate so that a standard corrosion allowance, generally of 1 to 5 mm, allows a service life of the equipment of greater than 10 years, more generally compatible with the service life anticipated for the unit. Within the context of the present invention this means in particular that it is not standard carbon steel, without any particular surface treatment;
“perforated grid”: a system permeable to gas, impermeable to the particles of adsorbents and having sufficient mechanical characteristics to guarantee a reliable operation of the purification plant for several years; in other words, the grid will hold up over time and keep the adsorbents in place;
“internal grid”: the grid closest to the central axis; and
“external grid”: the grid closest to the outer wall of the adsorber.

A perforated grid may be composed of several elements, for example a grid having a thickness of 6 or 8 mm with wide openings onto which a metallic fabric having openings of less than a millimeter is pressed.

Generally for a radial adsorber, depending on the number of different adsorbents used, intermediate grids are added. In practice, if N is the number of layers of adsorbents, N−1 intermediate grids, i.e. in total N+1 grilles, should be used.

As an example as means for the centrifugal circulation of the gas stream, mention may be made of the inlet pipe into the adsorber, the central empty volume, the optional central gas distribution system, the inter-wall space between the shell and the external grid, the outlet pipe in one end wall, the deflector and the optional filters, with which it is possible to combine the valves and the various pipework.

In another case, the plant according to the invention may have one or more of the following features:
said plant is of TSA type and comprises means for circulating the regeneration gas in a centripetal manner. Thus, the regeneration gas loaded with impurities will exit through the center of the adsorber which is designed for such harsh conditions (acid conditions);
the equipment of the plant in contact with the regeneration gas at the adsorber outlet is made of corrosion-resistant material;
said plant is of PSA type and comprises means for circulating the waste gas in a centripetal manner;
the equipment of the plant in contact with the waste gas is made of corrosion-resistant material. Without wishing to go into detail of the PSA cycles widely described in the literature, the waste gas is extracted countercurrently from the feed gas during steps commonly referred to as “final countercurrent decompression” (or Blow Down) and “elution” (or Purge). This waste gas is extracted at lower pressure than the adsorption pressure and contains the most highly adsorbable constituents. It will be noted that this waste gas may constitute the fraction that it is desired to produce. It will nevertheless be referred to here as waste gas in any case;
the corrosion-resistant material is selected from stainless steels, noble metals, polymers, ceramics and carbon steel covered with an anti-corrosion material. An anti-corrosion material is understood to mean paint, galvanization, electrogalvanization, stainless steel plating, Teflon deposition, in particular;
the external grid is made of carbon steel. It is noted that should several adsorbants be used, the intermediate grids are made of carbon steel;
at least one end wall of the adsorber is made of carbon steel, preferably the two end walls of the adsorber are made of carbon steel. This assumes that they are not in contact with the corrosive impurities. This is generally possible as represented in FIG. 3 where the end walls 10 and 11 are not subjected to the gas to be treated, nor the regeneration gas at the outlet. This applies to TSA (subject of the description) but also to PSA or to guard beds;
the vertically-held adsorbent rests on a support having a slope oriented toward the central axis of the adsorber. The lower support of the adsorbent layer is generally flat for a uniform distribution of the gas streams through the adsorbent. Nevertheless, this support is sometimes curved to a better mechanical behavior. This is the case for example in FIGS. 2 and 3. For a plant according to the invention, the internal portion of this lower support has a slope oriented toward the center (unlike the support from FIGS. 2 and 3) in order to facilitate the gravity flow of the liquids optionally formed during the cycle toward the internal portion of the adsorber, then from there toward the bottom point of the plant from where they will preferably be discharged via a purge. It may be a curved end wall, but installed in the “opposite” direction to that represented in FIGS. 2 and 3;
said plant comprises at least one means of collecting and extracting liquids from the adsorber that originate from the gas stream to be purified and/or are formed during the regeneration. These liquids could be extracted from the plant through a valve that opens onto a purge circuit with said valve preferably automated and linked to the adsorption cycle;
the vertically-held adsorbent is selected from silica gel, porous glass, resins, silicalite, activated carbon and zeolite 3A.

Certain adsorbents may also be chemically attacked by the impurities that are corrosive for the carbon steel. In order to avoid having to change the adsorbents, or at least the adsorbent of the first layer, too rapidly, it is advisable to use adsorbents that are also resistant to these impurities, even if they are less effective as adsorbents. Among these, mention may be made of the adsorbents that have just been mentioned, that is to say microporous glass, zeolite 3A (which will selectively adsorb water), certain silica gels, and silicalites. Activated carbon also has a good resistance to acids. Mention may also be made, as adsorbants that are particularly resistant, of insoluble macromolecules of polymer type, for example based on crosslinked polystyrene or crosslinked polyacrylate, comprising macroporosities and/or microporosities having a size that enables them to adsorb and/or condense the moisture from the gas to be treated. Among these, the various ion-exchange resins may constitute a relatively good value adsorbent for carrying out at least a first portion of the drying.

It is noted that, besides the internal grid that holds the adsorbent mass in place, the central portion may comprise, as described previously, a filter and/or a gas distributor, for example a perforated tube or a cone, and also connecting parts between the inlet/outlet flange and these elements. These elements are preferably made of a corrosion-resistant material. It will be noted however that some of these pieces of equipment may be changed relatively easily and that it is possible to consider them to be parts to be replace periodically that will be made from carbon steel. This is an economical choice to make as a function of the various parameters (respective costs of the materials, service life, maintenance policy).

Another subject of the invention is a process for purifying a gas stream comprising at least one impurity that is corrosive with respect to carbon steel, using a plant according to the invention and wherein the corrosive impurity is selected:
from the group of acids: HCl, HNO₃, HF and H₂SO₄; or
from the group of gases: NOx, SOx and H₂S in the presence of moisture.

Preferably, the gas stream is a gas stream resulting from combustion, preferably from oxy-fuel combustion, or resulting from metallurgy, preferably from blast furnace gases.

It is noted that the process according to the invention may be a drying or CO₂ stripping process.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 illustrates a schematic representation of a radial adsorber indicating various flow regimes.

FIG. 2 illustrates a schematic representation of a radial adsorber.

FIG. 3 illustrates a schematic representation of a radial adsorber including two separate layers of adsorbents; and

FIG. 4 illustrates a schematic representation of one embodiment of the present invention.

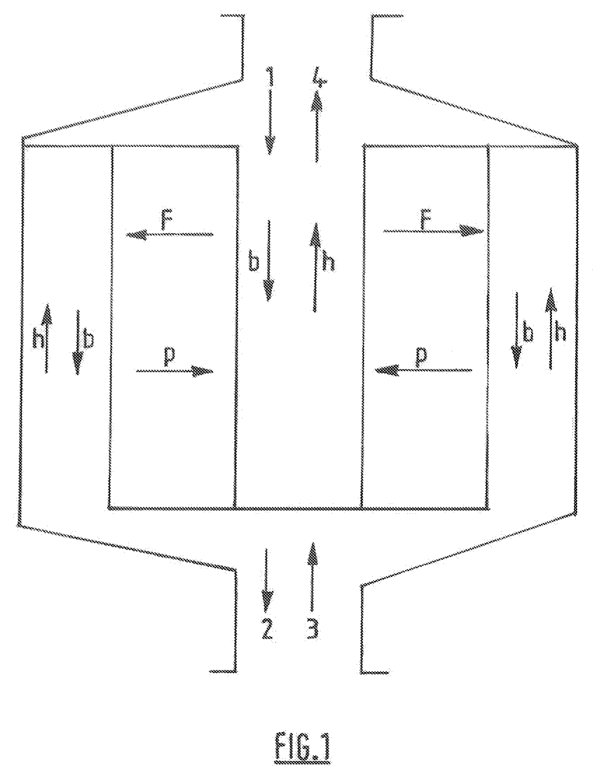

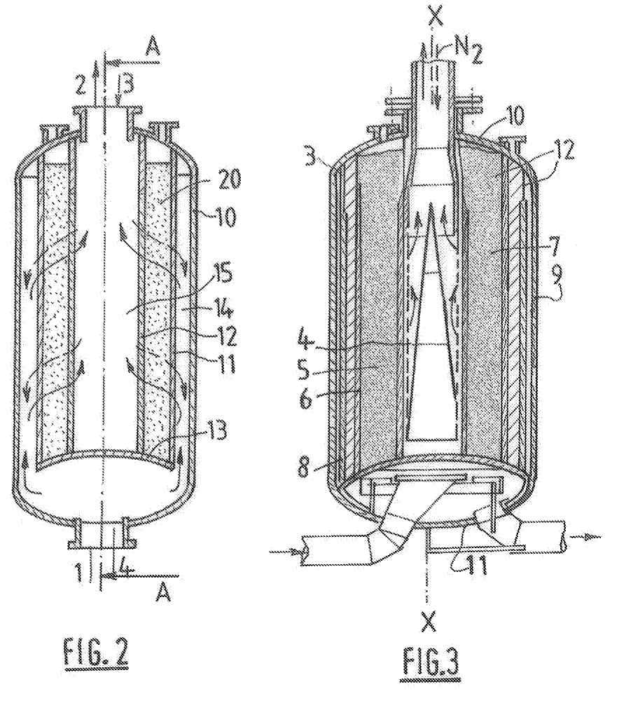

### DESCRIPTION OF PREFERRED EMBODIMENTS

According to one particular case, the invention relates to a process for purifying a gas stream comprising at least one impurity that is corrosive with respect to carbon steel, using a plant according to the invention comprising at least one means of collecting and extracting liquids from the adsorber that originate from the gas stream to be purified and/or are formed during the regeneration and wherein the corrosive impurity is selected:
from the group of acids: HCl, HNO₃, HF and H₂SO₄; or
from the group of gases: NOx, SOx and H₂S in the presence of moisture; and the liquids extracted from the absorber are recycled in acid water washing processes or acid production processes.

The invention will now be described in detail within the context of a CO₂ capture process. It is recalled that in order to reduce emissions of CO₂ of human origin in the atmosphere, it is a question of extracting the CO₂ from a gas generated by an industrial process, optionally to purify it and finally, in general, to compress it in order to transport it in a pipeline. This treatment generally necessitates at least partially drying the CO₂.

The gases resulting from processes of oxy-fuel combustion type are good candidates since they have a high content of CO₂, the nitrogen having been eliminated from the air before combustion. These gases also contain a percentage of NOx (NO & NO₂ predominantly) resulting from the combustion. These NOx will enter the adsorbers that aim to dry the CO₂ in the form of NO, NO₂ and also in the form of nitric acid (HNO₃) resulting from the conversion of NO to give NO₂ and of NO₂ to give HNO₃, in particular if the purification takes place after compression and cooling. HNO₃ is retained by the adsorbent of the adsorbers and NO and NO₂ are partially retained. In the adsorber, the reactions for converting NO to give NO₂ and NO₂ to give HNO₃ are accelerated and the equilibria are shifted toward the formation of HNO₃. At the time of the regeneration of the adsorbent, during the desorption of the previously adsorbed NOx, there is also a possibility of forming nitric acid in the presence of water trapped during the adsorption. The hot nitric acid formed and/or desorbed during the regeneration and also the water vapor desorbed will have a tendency to condense on the coldest zones located toward the outlet of the adsorber. The condensates formed will then contain a high concentration of nitric acid.

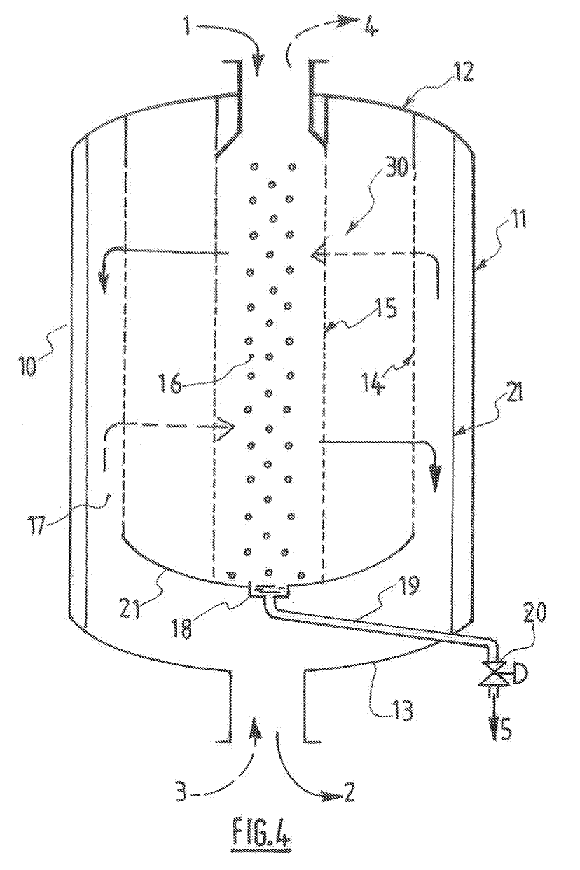

Reference is now made to FIG. 4, which represents a radial adsorber 10 according to the invention. The dimensions of this adsorber will depend on the flow rate of gas to be dried and on the operating conditions. Generally, the diameter of the shell varies from 2 meters to 6 meters and its height varies from 4 meters to more than 20 meters. The oxy-fuel combustion gas 1 to be dried is introduced in the upper portion, is distributed by means of the distributor 16 across the adsorbent mass 30, which here is a single bed of silica gel. This bed is held in place by the grids 14 and 15 to which the end wall 21 is attached. The dried gas 2 flows into the inter-wall space 17 then leaves through the lower portion of the adsorber. The regeneration gas 3 is introduced countercurrently firstly hot (heating step) then at ambient temperature (cooling step). It leaves the adsorber via the center and the upper end wall 4. Since the regeneration is carried out at 200° C., insulation by a simple gas-filled space 21 has been provided. The gas contained in this space is at equal pressure with respect to the gas circulating in the inter-wall space. The connection between the two gaseous volumes is provided here in the upper portion in order to limit the convection phenomena but other locations are possible according to the criteria adopted.

The liquids formed are collected by gravity in the volume 18 located at the bottom point of the support end wall 21. These liquids may originate from droplets present in the gas to be treated 1, the distributor 16 acting as gas/liquid separator or as already described from the condensation of vapor during the regeneration phase on the coldest portions located downstream. The shape of the support end wall 21 favors the entrainment of the liquids toward the central portion and the volume 18. These liquids are purged via the line 19 and the valve 20.

The volume 18 and the line 19 will advantageously be insulated in order to prevent a re-vaporization of the liquids 5. These highly concentrated liquids will advantageously be treated before the discharging thereof or optionally used for other applications. Among the latter, mention may be made of the most effective gas washing operations with waters having an acid pH, or for example the washing of coal or coal residues after combustion to extract therefrom the metals (iron, arsenic, mercury, vanadium, etc.) in order to recycle these constituents or to preventively remove them from the coal. These condensates may also act as raw material for the manufacture of acid.

The internal elements of the adsorber 10, such as the grids 14 and 15 and the line 19 for example, are designed so that their differential heat expansion between the steps of the TSA cycle (adsorption and regeneration) or between the various elements at a given moment of the cycle do not result in irreversible deformations that endanger the correct operation of the plant of the invention (loss of gas tightness, significantly heterogeneous thickness of the adsorbent mass, etc.). For example, the line 19 may have a coil shape (not represented in FIG. 4).

The upper flange, the distributor 16, the internal grid 15, the adjoining part between the flange and the internal grid, the reservoir 18, the support end wall 21, the line 19 and optionally the body of the valve 20 are made of stainless steel of NAG (Nitric Acid Grade) type. The shell 11 and the end walls 12 and 13, the external grid 14, the envelope of the insulating gas-filled space are made of carbon steel.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1-12. (canceled)

13. A TSA or PSA adsorption plant for purifying a gas stream comprising at least one impurity that is corrosive with respect to carbon steel, the plant comprising a radial adsorber comprising:
a shell with an outer envelope made of carbon steel;
a vertical and perforated internal grid made of corrosion-resistant material;
a vertical and perforated external grid made of carbon steel;
an adsorbent held vertically by the external grid and the internal grid, the adsorbent being resistant to the corrosive impurity, and configured to at least partially stop said corrosive impurity;
a means configured to produce a centrifugal circulation of the gas stream; and
a means configured to circulate the regeneration gas in a centripetal manner.

14. The plant of claim 13, wherein the plant comprises a TSA and the equipment of the plant in contact with the regeneration gas at the adsorber outlet is made of corrosion-resistant material.

15. The plant of claim 13, wherein the plant comprises a PSA and the equipment of the plant in contact with the waste gas is made of corrosion-resistant material.

16. The plant of claim 13, wherein the corrosion-resistant material is selected from the group consisting of stainless steels, noble metals, polymers, ceramics and carbon steel covered with an anti-corrosion material.

17. The plant of claim 13, wherein at least one end wall of the adsorber is made of carbon steel.

18. The plant of claim 13, wherein the vertically-held adsorbent rests on a support having a slope oriented toward the central axis of the adsorber.

19. The plant of claim 13, wherein said plant comprises at least one means of collecting and extracting liquids from the adsorber that originate from the gas stream to be purified and/or are formed during the regeneration.

20. The plant of claim 13, wherein the vertically-held adsorbent is selected from the group consisting of silica gel, porous glass, resins, silicalite, activated carbon and zeolite 3A.

21. A process for purifying a gas stream comprising at least one impurity that is corrosive with respect to carbon steel, using a plant of claim 1, and wherein the corrosive impurity is selected:
from the group of acids: HCl, HNO₃, HF and H₂SO₄; or
from the group of gases: NOx, SOx and H₂S in the presence of moisture.

22. The process of claim 21, wherein the gas stream is a gas stream resulting from combustion or resulting from metallurgy.

23. The process of claim 21, wherein the process is a drying or CO₂ stripping process.

24. A process for purifying a gas stream comprising at least one impurity that is corrosive with respect to carbon steel, using a plant of claim 19, and wherein the corrosive impurity is selected:
from the group of acids: HCl, HNO₃, HF and H₂SO₄; or
from the group of gases: NOx, SOx and H₂S in the presence of moisture; and the liquids extracted from the adsorber are recycled in acid water washing processes or acid production processes.
